(19) United States
(12) Patent Application Publication
(10) Pub. No.: US 2023/0406751 A1
(43) Pub. Date: Dec. 21, 2023

(54) OPTICAL FIBER MANUFACTURING METHOD AND MANUFACTURING APPARATUS

(71) Applicant: SUMITOMO ELECTRIC INDUSTRIES, LTD., Osaka-shi, Osaka (JP)

(72) Inventors: Hiroshi KOHDA, Osaka (JP); Shinobu HATA, Osaka (JP); Satoshi YOSHIKAWA, Osaka (JP); Iwao OKAZAKI, Osaka (JP)

(73) Assignee: SUMITOMO ELECTRIC INDUSTRIES, LTD., Osaka-shi, Osaka (JP)

(21) Appl. No.: 18/036,767

(22) PCT Filed: Nov. 12, 2021
(86) PCT No.: PCT/JP2021/041756

§ 371 Date: May 12, 2023

(30) Foreign Application Priority Data
Nov. 13, 2020 (JP) 2020-189691

(51) Int. Cl. C03B 37/025

(52) U.S. Cl. CPC C03B 37/0253; C03B 2205/46

(57) ABSTRACT

Provided is an optical fiber manufacturing method where an optical fiber preform is drawn while being heated in a drawing furnace to form an optical fiber, the method including acquiring a captured image obtained by simultaneously photographing the optical fiber preform and an opening of the drawing furnace before drawing the optical fiber preform, and adjusting a position of the optical fiber preform so that a center of the optical fiber preform and a center of the opening match based on the captured image.

### TECHNICAL FIELD

The present disclosure relates to an optical fiber manufacturing method and an optical fiber manufacturing apparatus.

This application claims priority based on Japanese Application No. 2020-189691 filed on Nov. 13, 2020, and incorporates all the descriptions described in the Japanese Application.

### BACKGROUND ART

Patent Literature 1 discloses an optical fiber preform centering device in which, in an apparatus for non-contact optical positioning of an optical fiber preform, a light source and a photodetector are located on the same optical axis, a light beam emitted from the light source is directed toward the photodetector, and the optical fiber preform is located so as to cross the light beam between the light source and the photodetector.

### CITATION LIST

### Patent Literature

Patent Literature 1: JPS60-231438A

### SUMMARY OF INVENTION

An optical fiber manufacturing method according to an aspect of the present disclosure is,
an optical fiber manufacturing method where an optical fiber preform is drawn while being heated in a drawing furnace to form an optical fiber, the method including,
acquiring a captured image obtained by simultaneously photographing the optical fiber preform and an opening of the drawing furnace before drawing the optical fiber preform, and
adjusting a position of the optical fiber preform so that a center of the optical fiber preform and a center of the opening match based on the captured image.

An optical fiber manufacturing apparatus according to another aspect of the present disclosure includes,
a drawing furnace that heats and draws an optical fiber preform to form an optical fiber;
a feeder that can grip an upper end of the optical fiber preform and move a position of the optical fiber preform;
at least one camera for simultaneously photographing the optical fiber preform and the opening of the drawing furnace before drawing the optical fiber preform; and
a control unit for controlling the feeder so that a center of the optical fiber preform and a center of the opening match based on the captured image acquired by the at least one camera.

### BRIEF DESCRIPTION OF DRAWINGS

FIG. 1 is a schematic configuration diagram illustrating an optical fiber manufacturing apparatus according to an embodiment of the present disclosure.

FIG. 2 is a schematic diagram illustrating an upper structure of the manufacturing apparatus including an imaging unit and a drawing furnace.

FIG. 3 is a top view of the imaging unit illustrated in FIG. 2.

FIG. 4A is an image illustrating an optical fiber preform and an opening of the drawing furnace captured by a first camera in the imaging unit without illumination by an illumination device.

FIG. 4B is an image illustrating the optical fiber preform and the opening of the drawing furnace captured by a second camera in the imaging unit without illumination by the illumination device.

FIG. 5A is an image illustrating the optical fiber preform and the opening of the drawing furnace captured by the first camera with illumination by a first illumination device in the imaging unit.

FIG. 5B is an image illustrating the optical fiber preform and the opening of the drawing furnace captured by a second camera with illumination by a second illumination device in the imaging unit.

FIG. 6 is a diagram illustrating a center position of the optical fiber preform and a center position of the opening of the drawing furnace detected by image processing.

FIG. 7 is a timing chart illustrating timings of light rays emitted from a first illumination device and a second illumination device and opening and closing of shutters of a first camera and a second camera according to a modification example.

### DESCRIPTION OF EMBODIMENTS

### Problems to be Solved by Present Disclosure

In order to optically adjust a position of an optical fiber preform in a non-contact manner as in Patent Literature 1, when the optical fiber preform is centered by irradiation with a light beam, if positions of a light source and a photodetector are deviated, the optical fiber preform cannot be accurately centered. Therefore, periodic maintenance of these devices is required so that the positions of the light source and the photodetector do not shift.

Accordingly, an object of the present disclosure is to provide an optical fiber manufacturing method and an optical fiber manufacturing apparatus which can accurately and easily center an optical fiber preform and a drawing furnace.

### Description of Embodiments of Present Disclosure

First, embodiments of the present disclosure are listed and described.

An optical fiber manufacturing method according to an aspect of the present disclosure is,

(1) an optical fiber manufacturing method where an optical fiber preform is drawn while being heated in a drawing furnace to form an optical fiber, the method including,
acquiring a captured image obtained by simultaneously photographing the optical fiber preform and an opening of the drawing furnace before drawing the optical fiber preform, and
adjusting a position of the optical fiber preform so that a center of the optical fiber preform and a center of the opening match based on the captured image.

The present disclosure allows accurate and easy center alignment of the optical fiber preform (glass preform) and the drawing furnace. Therefore, it is possible to prevent, for example, disconnection or asymmetry of the optical fiber after drawing due to eccentricity of a melting point of the optical fiber preform, or the optical fiber preform from colliding with the opening of the drawing furnace when the optical fiber preform is inserted into the drawing furnace, which are caused by drawing with a central axis of the optical fiber preform inclined. Further, as described above, when the core alignment adjustment is performed using a laser or the like, periodic maintenance of a position adjustment mechanism is required in order to accurately align a laser position. In the method of the present disclosure, since it is possible to adjust the position of the optical fiber preform based on the captured image including both the optical fiber preform and the opening of the drawing furnace, positions of imaging mechanisms can be deviated as long as captured images including both the optical fiber preform and the opening of the drawing furnace can be obtained, and thus periodic maintenance for the imaging mechanisms becomes unnecessary.

“The positions of the center of the optical fiber preform and the center of the opening match” does not need to match completely, and a deviation of about 1 mm is allowed.

(2) The captured image may include a first captured image and a second captured image, and
in acquiring the captured image,
the first captured image may be acquired by photographing the optical fiber preform and the opening with a first camera, and the second captured image may be acquired by photographing the optical fiber preform and the opening with a second camera installed at a position different from the first camera.

According to the present disclosure, by using a plurality of first and second cameras, it is possible to acquire the first captured image and the second captured image captured from different photographing locations. Since the deviation between the center of the optical fiber preform and the center of the opening of the drawing furnace can be detected from two directions, it is possible to align the center of the optical fiber preform and the center of the drawing furnace more accurately.

(3) In acquiring the captured image,
the optical fiber preform may be irradiated with a first light ray emitted from a first illumination device,
the optical fiber preform may be irradiated with a second light ray emitted from a second illumination device and having a wavelength different from that of the first light ray,
a first captured image may be acquired by photographing the optical fiber preform and the opening with a first camera having a first filter capable of transmitting only the first light ray, and
a second captured image may be acquired by photographing the optical fiber preform and the opening with a second camera having a second filter capable of transmitting only the second light ray.

According to this disclosure, an image illuminated only by the first light rays of the first illumination device suitable for acquiring the first captured image is acquired by the first camera with the first filter, and by reducing an influence of light rays of other wavelengths from other illumination, it is possible to acquire a captured image in which the outline edge of the optical fiber preform can be easily recognized. As a result, the optical fiber preform and the drawing furnace can be precisely centered. A similar effect can be obtained in the second camera by using the second filter and the second illumination device.

Although respective filters transmit only the wavelengths of the first light rays and the second light rays, the first filter provided in the first camera does not block all the wavelengths of the second light rays, but transmits light rays of some wavelengths (which overlap with a wavelength distribution of the first light rays). Similarly, the second filter provided in the second camera does not block all the wavelengths of the first light rays, but allows some of the wavelengths (which overlap with a wavelength distribution of the second light rays) to pass through.

Also, the first filter transmits light rays having the wavelength of the first light rays, but does not transmit only the light rays emitted from the first illumination device. Similarly, the second filter transmits light rays having the wavelength of the second light rays, but does not transmit only the light rays emitted from the second illumination device.

(4) A wavelength of the first light ray may be red and a wavelength of the second light ray may be blue.

By using a red light ray and a blue light ray for the colors of the first light ray and the second light ray, respectively, the difference in wavelength between the first light ray and the second light ray becomes large. Therefore, the first light ray is blocked by the second filter and is less likely to enter the second camera, and similarly the second light ray is blocked by the first filter and is less likely to enter the first camera. In this way, by reducing an influence of light rays of other wavelengths, it is possible to acquire a captured image in which the outline edges of the optical fiber preform can be easily recognized. “Red” has a wavelength of about 600 nm to 800 nm, and “blue” has a wavelength of about 400 nm to 500 nm.

(5) Acquiring the captured image may include,
irradiating the optical fiber preform with a first light ray emitted from a first illumination device at a first timing,
opening a shutter of a first camera in accordance with the first timing to acquire the captured image illuminated only by the first light ray,
irradiating the optical fiber preform with a second light ray emitted from a second illumination device at a second timing different from the first timing, and
opening a shutter of a second camera in accordance with the second timing to acquire the captured image illuminated only by the second light ray.

As described in the present disclosure, by using a plurality of illumination devices with different light emission timing and performing photographing in accordance with the timing of light emission from each illumination device, it is possible to acquire an image illuminated only by each light ray of each illumination device suitable for acquiring each captured image of each camera. Therefore, it is possible to acquire a captured image that makes it easy to recognize an outline edge of the optical fiber preform. As a result, more accurate center alignment of the optical fiber preform and the drawing furnace can be achieved.

(6) In acquiring the captured image, the optical fiber preform may be irradiated with a reflected light ray reflected by a screen located on a back surface of the optical fiber preform.

By using the transmission illumination of the reflected light rays from the screen, it is possible to illuminate the optical fiber preform evenly from a direction facing the camera, so it is possible to acquire a captured image that makes it easier to recognize the outline edge of the optical fiber preform.

An optical fiber manufacturing apparatus according to another aspect of the present disclosure may include,

(7) a drawing furnace that heats and draws an optical fiber preform to form an optical fiber;
a feeder that can grip an upper end of the optical fiber preform and move a position of the optical fiber preform;
at least one camera for simultaneously photographing the optical fiber preform and the opening of the drawing furnace before drawing the optical fiber preform; and
a control unit for controlling the feeder so that a center of the optical fiber preform and a center of the opening match based on the captured image acquired by the at least one camera.

According to the present disclosure, it is possible to provide the optical fiber manufacturing apparatus capable of accurately and easily executing core alignment of the optical fiber preform, and thus it can prevent occurrence of disconnection or asymmetry of the optical fiber after drawing, and collision of the optical fiber preform with the opening of the drawing furnace.

### Effect of Present Disclosure

According to the present disclosure, it is possible to provide an optical fiber manufacturing method and an optical fiber manufacturing apparatus which can accurately and easily center an optical fiber preform and a drawing furnace.

### Details of Embodiments of Present Disclosure

A specific example of an optical fiber manufacturing method and an optical fiber manufacturing apparatus according to an embodiment of the present disclosure will be described with reference to the drawings. The present disclosure is not limited to these examples, but is indicated by the scope of the claims, and is intended to include all modifications within the meaning and scope of equivalents of the claims.

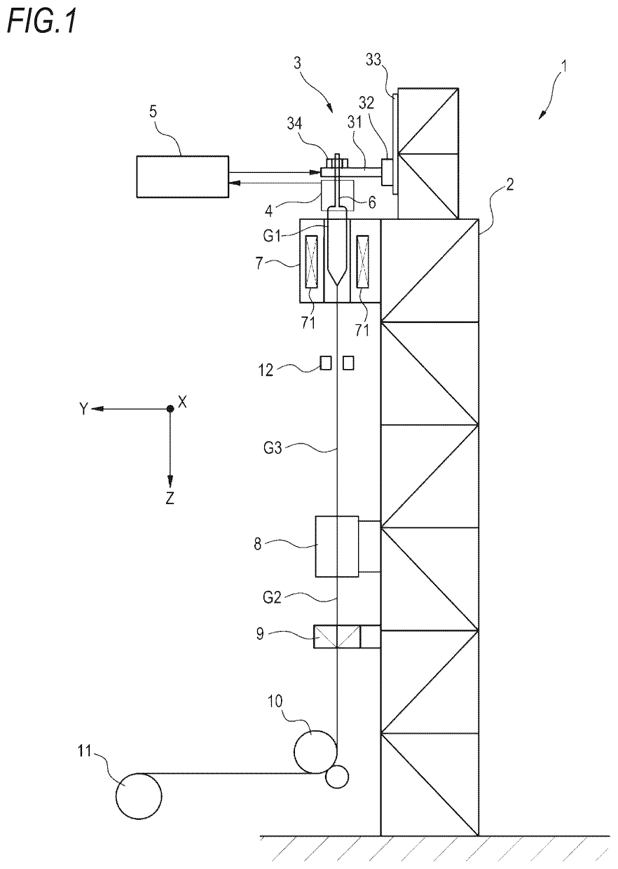

FIG. 1 is a configuration diagram illustrating an optical fiber manufacturing apparatus 1 according to the present embodiment.

As illustrated in FIG. 1, an optical fiber manufacturing apparatus 1 includes a drawing tower 2, a feeder 3, an imaging unit 4, a control unit 5, a support rod 6, a drawing furnace 7, a forced cooling device 8, a coating device 9, a capstan device 10, a winding device 11, and a glass outer diameter measuring device 12.

The feeder 3 is provided on an upper part of the drawing tower 2 and is configured to be able to move a position of an optical fiber preform (glass preform) G1. The feeder 3 has a chuck 31, a chuck support portion 32, a vertical moving portion 33, and a horizontal moving portion 34.

The chuck 31 grips the support rod 6 provided on an upper side of the optical fiber preform G1. The chuck support portion 32 cantilevers the chuck 31 to the drawing tower 2. The vertical moving portion 33 is provided along a vertical direction (Z direction) of the manufacturing apparatus 1 and is configured to move the chuck support portion 32 in the vertical direction. By moving the chuck support portion 32 vertically, the vertical moving portion 33 vertically moves the optical fiber preform G1 gripped by the chuck 31 together with the chuck support portion 32. The horizontal moving portion 34 is configured to move the optical fiber preform G1 gripped by the chuck 31 in horizontal directions (X direction and Y direction) orthogonal to the vertical direction.

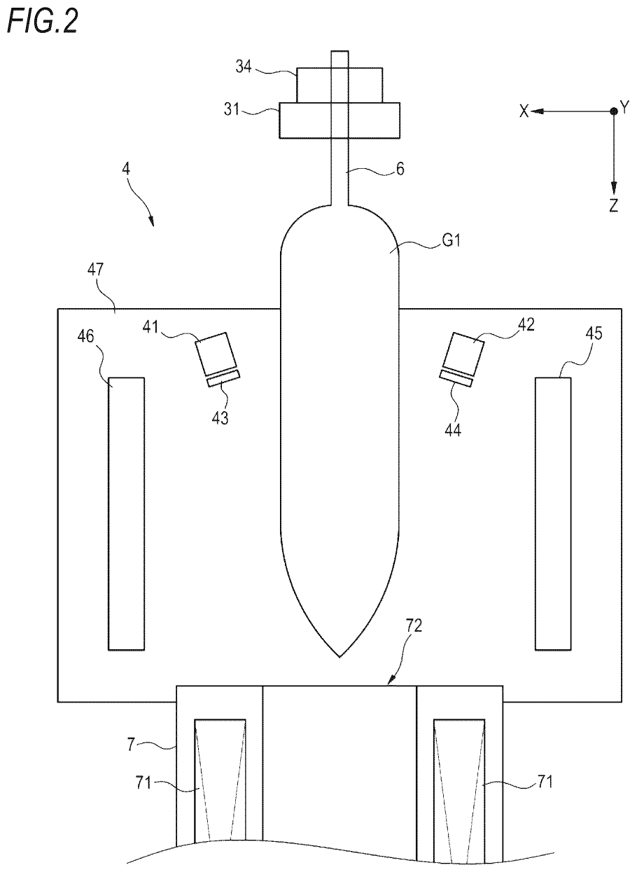

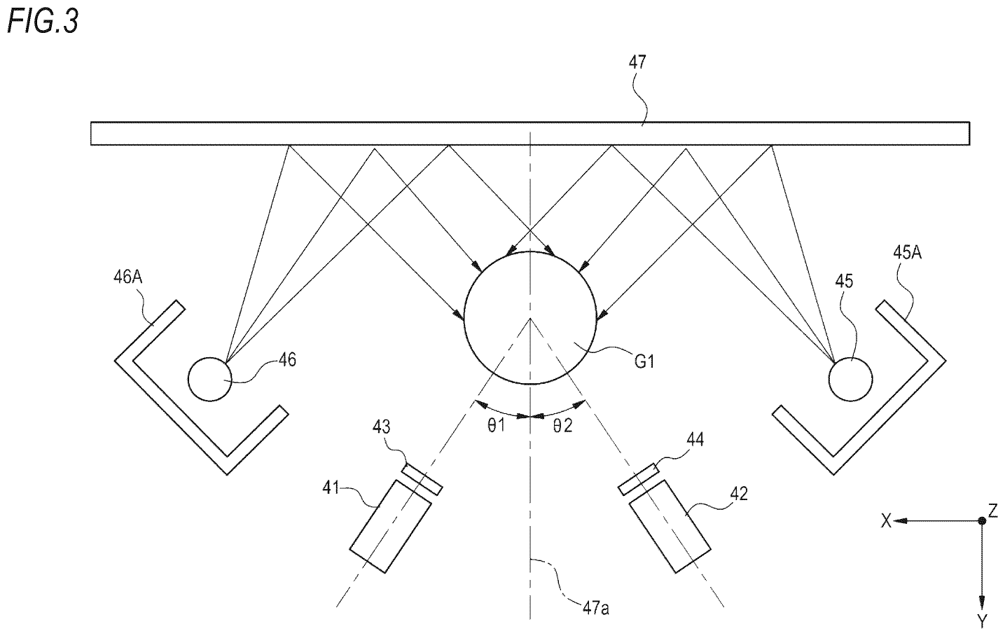

The imaging unit 4 is provided at least above the drawing furnace 7 in the vertical direction. For example, the imaging unit 4 is provided so as to simultaneously image an opening formed in an upper portion of the drawing furnace 7 and the optical fiber preform G1 accommodated in the opening. In an example illustrated in FIG. 1, the imaging unit 4 is provided above the drawing furnace 7 and below the chuck 31. A detailed configuration of the imaging unit 4 will be described below with reference to FIGS. 2 and 3.

The drawing furnace 7 is supported on an upper side of the drawing tower 2, has a heater 71, and heats the optical fiber preform G1 accommodated therein. The optical fiber preform G1 heated and melted in the drawing furnace 7 is exposed from a tip and drawn as a glass fiber G3. The forced cooling device 8 forcedly cools the hot glass fiber G3 drawn in the drawing furnace 7. The coating device 9 coats the glass fiber G3 cooled by the forced cooling device 8 with a resin. An optical fiber G2 is formed by coating the glass fiber G3 with a resin. When the resin is an ultraviolet curing resin, an ultraviolet irradiation device may be provided below the coating device 9 to irradiate the optical fiber G2 with ultraviolet rays to cure the resin. After the resin hardens, the optical fiber G2 passes through the capstan device 10 and is wound by the winding device 11 under constant tension. The capstan device 10 is controlled based on a signal from the glass outer diameter measuring device 12, and an optical fiber G2 having a predetermined glass outer diameter is obtained.

The control unit 5 is connected to the vertical moving portion 33 and the horizontal moving portion 34 of the feeder 3, the imaging unit 4, and the like. The control unit 5 controls the horizontal moving portion 34 to adjust a horizontal (XY direction) position of the optical fiber preform G1 gripped by the chuck 31. The control unit 5 also controls the vertical moving portion 33 to adjust a vertical (Z direction) position of the optical fiber preform G1 gripped by the chuck 31. Then, the control unit 5 controls the feeder 3 based on imaging information acquired by the imaging unit 4 so that a center of the optical fiber preform G1 and a center of an opening 72 match.

FIG. 2 is a schematic diagram illustrating an upper structure of the manufacturing apparatus 1 including the imaging unit 4 and the drawing furnace 7 in FIG. 1. FIG. 3 is a top view of the imaging unit 4 illustrated in FIG. 2.

As illustrated in FIGS. 2 and 3, the imaging unit 4 includes a first camera 41, a second camera 42, a red filter 43 (an example of a first filter), a blue filter 44 (an example of a second filter), a red LED 45 (an example of a first illumination device), a blue LED 46 (an example of a second illumination device), and a screen 47.

Each of the first camera 41 and the second camera 42 is provided so as to simultaneously image the opening 72 formed in an upper part of the drawing furnace 7 and the optical fiber preform G1 before being accommodated in the opening 72 (drawing furnace 7) from different positions. The optical fiber preform G1 before being accommodated in the opening 72 is the optical fiber preform G1 before being drawn, and is the optical fiber preform G1 in a state of being gripped by the chuck 31 via the support rod 6. The first camera 41 and the second camera 42 are provided at substantially symmetrical positions across the optical fiber preform G1 in the X direction. Also, the first camera 41 and the second camera 42 are provided above the opening 72 of the drawing furnace 7 in the Z direction. Further, the first camera 41 and the second camera 42 are provided so as to face diagonally downward and inward in order to simultaneously image the optical fiber preform G1 and the opening 72.

The red filter 43 capable of transmitting red light rays is attached to the first camera 41. The blue filter 44 capable of transmitting blue light rays is attached to the second camera 42.

The red LED 45 and the blue LED 46 are provided at substantially symmetrical positions across the optical fiber preform G1 in the X direction. The red LED 45 is located on the second camera 42 side to which the blue filter 44 is attached with respect to the optical fiber preform G1 in the X direction. The blue LED 46 is located on the first camera 41 side to which the red filter 43 is attached with respect to the optical fiber preform G1 in the X direction. In addition, the red LED 45 is located outside the second camera 42 with respect to the optical fiber preform G1 in the X direction. The blue LED 46 is located outside the first camera 41 with respect to the optical fiber preform G1 in the X direction.

The red LED 45 and the blue LED 46 are rod-shaped line type light sources provided along a length direction (Z direction) of the optical fiber preform G1. As illustrated in FIG. 3, the red LED 45 and the blue LED 46 are respectively provided with substantially U-shaped frames 45A and 46A that respectively surround the LEDs 45 and 46. The frames 45A and 46A are made of, for example, aluminum, and block the light rays emitted from the LEDs 45 and 46 from directly entering the first camera 41 and the second camera 42. In addition, inner sides of the frames 45A and 46A may be used as reflecting surfaces so that the light rays emitted from the respective LEDs 45 and 46 may be reflected on the reflecting surfaces so that the light rays emitted from the LEDs 45 and 46 are efficiently irradiated toward the screen 47.

The screen 47 is provided on an opposite side of the first camera 41 and the second camera 42 across the optical fiber preform G1 in the Y direction. The screen 47 is provided at a position that diffusely reflects the light rays emitted from the red LED 45 and the blue LED 46 toward the optical fiber preform G1. The screen 47 is provided on the drawing tower 2 side (back side of the optical fiber preform G1) with respect to the optical fiber preform G1 in the Y direction. The screen 47 is made of, for example, polyvinyl chloride resin of which a surface (reflective surface) is coated with white paint. The screen 47 reflects the light rays emitted from the red LED 45 and the blue LED 46 toward the optical fiber preform G1 so as to scatter the light rays over a wide angle.

The light rays emitted from the red LED 45 is reflected by the screen 47 and irradiated onto the optical fiber preform G1, as illustrated in FIG. 3. The light rays reflected by the screen 47 are applied as transmission illumination to the optical fiber preform G1, and then the light rays are captured through the red filter 43 by the first camera 41 provided on an opposite side of the screen 47 across the optical fiber preform G1 in the Y direction. Similarly, the light rays emitted from the blue LED 46 is reflected by the screen 47 and irradiated onto the optical fiber preform G1. The light rays reflected by the screen 47 is applied as transmission illumination to the optical fiber preform G1, and then the light rays are captured through the blue filter 44 by the second camera 42 provided on an opposite side of the screen 47 across the optical fiber preform G1 in the Y direction. The first camera 41 and the second camera 42 are respectively located at positions having predetermined angles θ1 and 02 (for example, 30 degrees to 60 degrees) with respect to a vertical line 47a drawn from the screen 47 through a center position of the optical fiber preform G1. The red LED 45 and the blue LED 46 are provided at positions such that the light rays reflected by the screen 47 can be efficiently emitted toward the first camera 41 and the second camera 42.

Next, the optical fiber manufacturing method according to the present embodiment will be described. The optical fiber manufacturing method of the present embodiment is a method for manufacturing the optical fiber G2 using the optical fiber manufacturing apparatus 1 illustrated in FIGS. 1 to 3. The optical fiber manufacturing method of the present embodiment includes the following “captured image acquisition process” and “position adjustment process”.

Imaging Acquisition Process

The chuck support portion 32 is slid upward by the vertical moving portion 33, and the support rod 6 of the optical fiber preform G1 used for wire drawing is gripped by the chuck 31. In a state where the optical fiber preform G1 is gripped by the chuck 31, before sliding the chuck support portion 32 downward, that is, before inserting the optical fiber preform G1 into the opening 72 of the drawing furnace 7, the optical fiber preform G1 and the opening 72 of the drawing furnace 7 are imaged by the first camera 41 and the second camera 42.

Specifically, the control unit 5 irradiates the optical fiber preform G1 with red light rays (an example of first light rays) emitted from the red LED 45 and irradiates the optical fiber preform G1 with blue light rays (an example of second light rays) emitted from the blue LED 46. In a state where the optical fiber preform G1 is illuminated by the light rays from each LED, the first camera 41 simultaneously images the optical fiber preform G1 and the opening 72 of the drawing furnace 7 through the red filter 43 to acquire a first captured image. Similarly, in a state where the optical fiber preform G1 is illuminated by the light rays from each LED, the second camera 42 simultaneously images the optical fiber preform G1 and the opening 72 of the drawing furnace 7 through the blue filter 44 to acquire a second captured image.

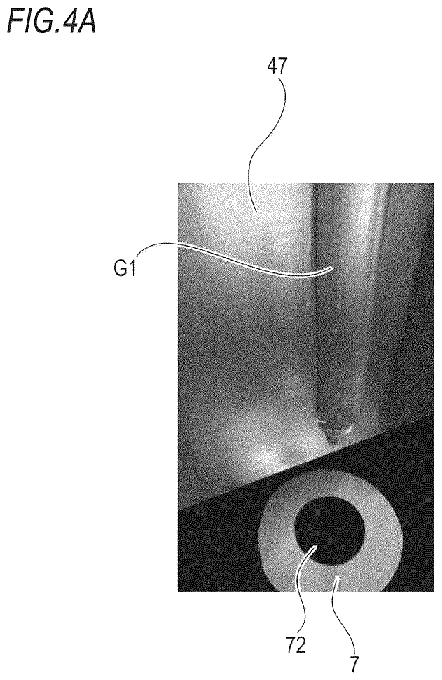

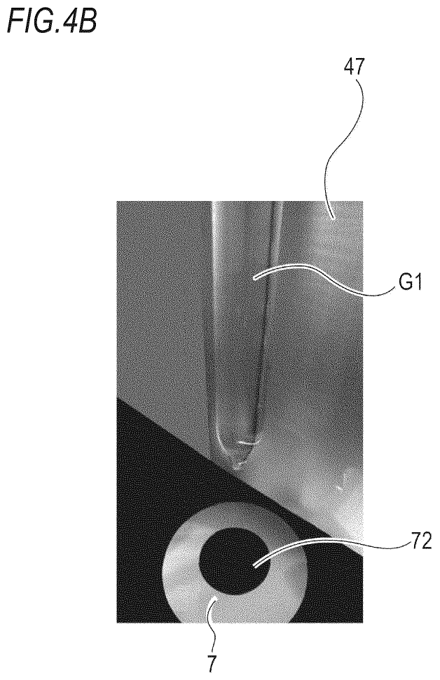

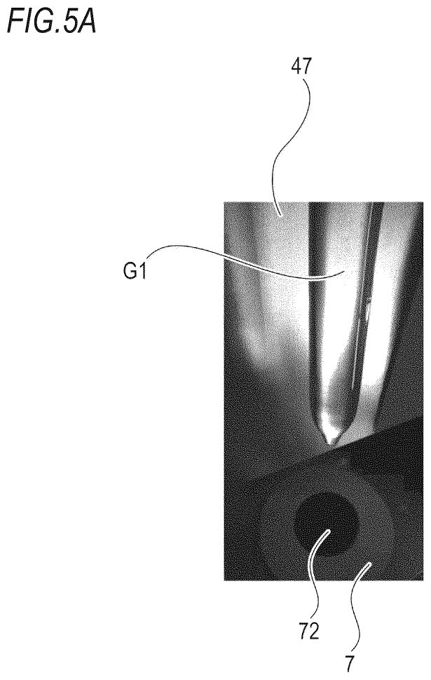

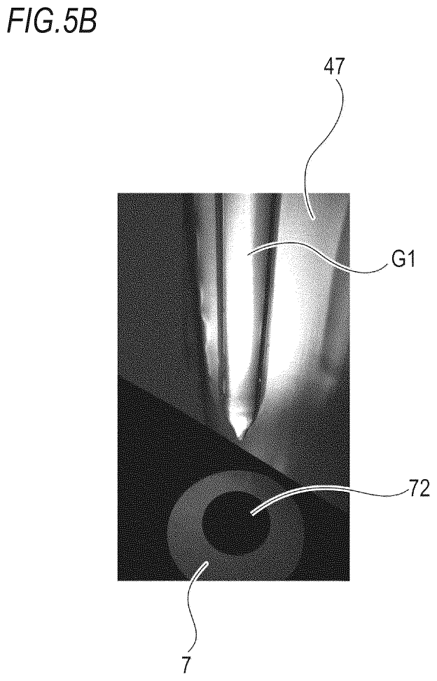

FIG. 4A is an image illustrating the optical fiber preform G1 and the opening 72 of the drawing furnace 7 captured by the first camera 41 without illumination by the red LED 45. FIG. 4B is an image illustrating the optical fiber preform G1 and the opening 72 of the drawing furnace 7 captured by the second camera 42 without illumination by the blue LED 46. FIG. 5A is an image (an example of the first captured image) illustrating the optical fiber preform G1 and the opening 72 of the drawing furnace 7 captured by the first camera 41 with the illumination by the red LED 45. FIG. 5B is an image (an example of the second captured image) illustrating the optical fiber preform G1 and the opening 72 of the drawing furnace 7 captured by the second camera 42 with illumination by the blue LED 46. That is, the images in FIGS. 4A and 4B are images when there is no illumination by the red LED 45 and the blue LED 46, and the images in FIGS. 5A and 5B are images when there is illumination by the red LED 45 and the blue LED 46.

As illustrated in the images of FIGS. 5A and 5B, when illuminated by the red LED 45 and the blue LED 46 and captured through the filters 43 and 44, in the optical fiber preform G1, which is a transparent cylinder, a background of the optical fiber preform G1 and the central portion of the optical fiber preform G1 appear white, and both side edge portions of the optical fiber preform G1 appear black due to transmission illumination by the light rays reflected by the screen 47. By using transmission illumination in this way, it is possible to acquire an image in which outline edges of the optical fiber preform G1 are emphasized. Therefore, the images (images in FIGS. 5A and 5B) when illuminated by the red LED 45 and the blue LED 46 are make it easier to recognize the outline edges of the optical fiber preform G1 than in the images (images in FIGS. 4A and 4B) without illumination.

On the other hand, when capturing without a filter under illumination by the red LED 45 and the blue LED 46, in addition to the transmission illumination, the light illuminating the optical fiber preform G1 from the side is also captured, so the outline edge enhancement of the optical fiber preform G1 is weakened, making it difficult to recognize the outline edge.

Position Adjustment Process

The control unit 5 detects edge coordinates of the optical fiber preform G1 and edge coordinates of the opening 72 of the drawing furnace 7 by image processing the first captured image captured by the first camera 41 and the second captured image captured by the second camera 42.

Next, the control unit 5 calculates a central axis of the optical fiber preform G1 based on the detected edge coordinates of the optical fiber preform G1. The central axis can be calculated, for example, as a bisector of two approximate straight lines obtained from the outline edge coordinates on both sides of the optical fiber preform G1. The control unit 5 also calculates a center point of an ellipse of the opening 72 based on the detected edge coordinates of the opening 72 of the drawing furnace 7. As described above, the first camera 41 and the second camera 42 are provided so as to face obliquely inward and downward in order to simultaneously image the optical fiber preform G1 and the opening 72 from different positions. Therefore, the outer diameter edges of the optical fiber preform G1 detected in the images of FIGS. 5A and 5B become closer to the center as it goes downward. Also, the shape of the opening 72 detected in the images of FIGS. 5A and 5B is substantially elliptical.

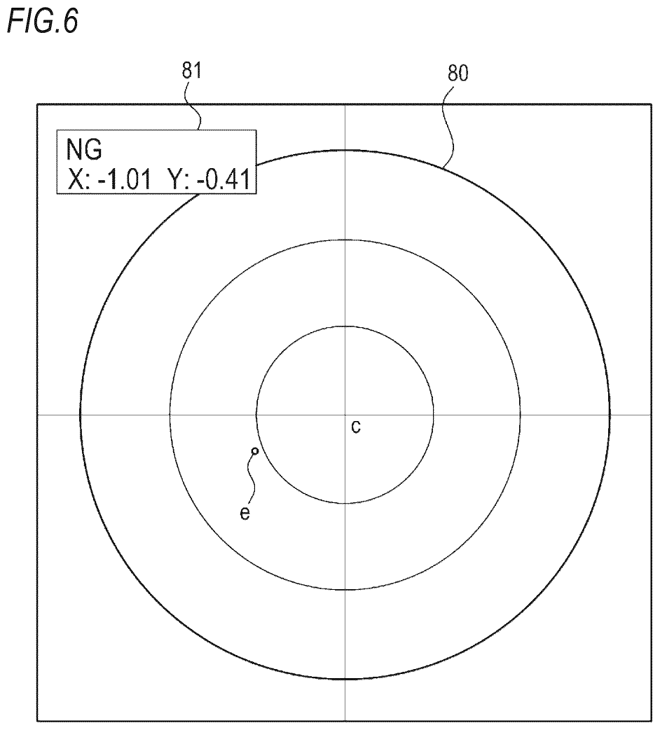

Next, the control unit 5 detects the center position of the optical fiber preform G1 based on the calculated central axis of the optical fiber preform G1, and detects the center position of the opening 72 based on the calculated center point of the ellipse of the opening 72. FIG. 6 is a diagram illustrating the center position of the optical fiber preform G1 and the center position of the opening 72 detected by image processing. In FIG. 6, a center position c is a core of the opening 72, and a target 80 with a radius of 3 mm to 5 mm, for example, is displayed. In the target 80, a center position e of the optical fiber preform G1 detected based on the edge coordinates of the optical fiber preform G1 detected by image processing the first captured image captured by the first camera 41 and the second captured image captured by the second camera 42 is plotted. The number displayed in an upper area 81 of the target 80 is a deviation amount (unit: mm) of the center position e of the optical fiber preform G1 from the center position c.

Next, the control unit 5 controls the horizontal moving portion 34 to adjust (center) the position of the optical fiber preform G1 based on the center position e of the optical fiber preform G1 and the center position c of the opening 72 plotted in FIG. 6 so that the center of the optical fiber preform G1 and the center of the opening 72 match. An operator may manually move the horizontal moving portion 34 to adjust (center) the position of the optical fiber preform G1.

Further, the horizontal moving portion 34 may be provided with a tilt moving portion (not illustrated) for adjusting a tilt of the optical fiber preform G1 with respect to the vertical moving portion 33 and the control unit 5 may control the tilt moving portion such that the tilt of the central axis of the optical fiber preform G1 is parallel to a movement direction of the vertical moving portion 33. As a result, it is possible to always align the center of the optical fiber preform G1 with the center of the opening 72 from a bottom end to a top end of the optical fiber preform G1.

The center position e of the optical fiber preform G1 and the center position c of the opening 72 are preferably calculated continuously. The control unit 5 may calculate the amount of deviation between the center position of the optical fiber preform G1 and the center position of the opening 72 based on data of the calculated center position and may numerically display the amount of deviation in real time as illustrated in the upper area 81 of FIG. 6, for example.

After completing the position adjustment process, the control unit 5 slides the chuck support portion 32 downward to accommodate the optical fiber preform G1 from the opening 72 into the drawing furnace 7. A subsequent wire drawing process is the same as the process of the related art, so the description is omitted.

As described above, the optical fiber manufacturing method according to the present embodiment includes a process of simultaneously photographing the optical fiber preform G1 and the opening 72 of the drawing furnace 7 before drawing the optical fiber preform G1 to acquire a captured image, and a process of adjusting the position of the optical fiber preform G1 so that the center of the optical fiber preform G1 is matched with the center of the opening 72 of the drawing furnace 7 based on the acquired captured image. According to the present manufacturing method, since it is possible to adjust the position of the optical fiber preform G1 by processing the captured image including both the optical fiber preform G1 and the opening 72 of the drawing furnace 7, center alignment of the optical fiber preform G1 and the opening 72 of the drawing furnace 7 can be performed accurately and easily. Therefore, it is possible to prevent, for example, disconnection or asymmetry of the optical fiber G2 after drawing due to eccentricity of a melting point of the optical fiber preform G1, or the optical fiber preform G1 from colliding with the opening 72 of the drawing furnace 7 when the optical fiber preform G1 is inserted into the drawing furnace 7, which are caused by drawing with the central axis of the optical fiber preform G1 inclined. In addition, when core alignment adjustment is performed using, for example, a laser as in the related art, periodic maintenance of a position adjustment mechanism is required in order to accurately align a laser position. In the case of the present manufacturing method, since it is possible to adjust the position of the optical fiber preform G1 based on the captured image including both the optical fiber preform G1 and the opening 72 of the drawing furnace 7, the positions of the imaging cameras 41 and 42 may be deviated as long as captured images including both the optical fiber preform G1 and the opening 72 of the drawing furnace 7 can be obtained, and thus periodic maintenance for alignment of the cameras 41 and 42 becomes unnecessary.

Also, the captured images include the first captured image and the second captured image, and in the process of acquiring the captured image, the first camera 41 captures the optical fiber preform G1 and the opening 72 to acquire the first captured image and the second camera 42 installed at a position different from that of the first camera 41 captures the optical fiber preform G1 and the opening 72 to acquire the second captured image. According to this method, by using a plurality of first and second cameras 41 and 42, it is possible to acquire the first captured image and the second captured image captured from different photographing locations. The deviation between the center of the optical fiber preform G1 and the center of the opening 72 of the drawing furnace 7 can be detected from two directions. Therefore, the center alignment between the optical fiber preform G1 and the drawing furnace 7 can be performed more accurately.

Further, in the process of acquiring the captured image, the optical fiber preform G1 is irradiated with red light rays emitted from the red LED 45 and the optical fiber preform G1 is irradiated with blue light rays emitted from the blue LED 46 and having a wavelength different from that of the red light rays, and then the optical fiber preform G1 and the opening 72 of the drawing furnace 7 are photographed by the first camera 41 equipped with the red filter 43 capable of transmitting only red light rays to acquire the image (an example of the first captured image) illustrated in FIG. 5A and the optical fiber preform G1 and the opening 72 of the drawing furnace 7 are photographed by the second camera 42 equipped with the blue filter 44 capable of transmitting only blue light rays to acquire the image (an example of the second captured image) illustrated in FIG. 5B. According to this method, the first camera 41 acquires the first captured image in which only the red light rays of the red LED 45 are irradiated by the red filter 43, and by reducing an influence of the blue light rays from the blue LED 46, it is possible to acquire a captured image in which the outline edge of the optical fiber preform G1 can be easily recognized. Similarly, the second camera 42 acquires the second captured image in which only the blue light rays of the blue LED 46 are irradiated by the blue filter 44, and by reducing an influence of the red light rays from the red LED 45, it is possible to acquire a captured image in which the outline edge of the optical fiber preform G1 can be easily recognized. Therefore, it is possible to accurately detect the center position of the optical fiber preform G1 and the center position of the opening 72 of the drawing furnace 7 based on the first captured image acquired by the first camera 41 and the second captured image acquired by the second camera 42. As a result, more precise center alignment of the optical fiber preform G1 and the opening 72 of the drawing furnace 7 can be achieved.

By using red light rays and blue light rays, the difference in wavelength between the two becomes large, so red light rays are blocked by the blue filter 44 and are less likely to enter the second camera 42. Similarly, blue light rays are blocked by the red filter 43 and are less likely to enter the first camera 41. In this way, by reducing the influence of light rays of other wavelengths, it is possible to acquire a captured image in which the outline edges of the optical fiber preform G1 can be easily recognized.

In addition, in the process of acquiring the captured image, the optical fiber preform G1 is irradiated with reflected light rays from the screen 47 located on a back surface of the optical fiber preform G1. According to this method, it is possible to evenly illuminate the optical fiber preform G1 by using the transmission illumination of the reflected light rays scattered by the screen 47. Therefore, it is possible to acquire the captured image in which the outline edge of the optical fiber preform G1 can be more easily recognized.

Further, the optical fiber manufacturing apparatus 1 according to the present embodiment includes the drawing furnace 7 for drawing while heating the optical fiber preform G1 to form the optical fiber G2, the feeder 3 capable of moving the position of the optical fiber preform G1 by gripping the upper end of the optical fiber preform G1, the first camera 41 and the second camera 42 for simultaneously photographing the optical fiber preform G1 and the opening 72 of the drawing furnace 7 before drawing the optical fiber preform G1, the control unit 5 that controls the feeder 3 so that the center of the optical fiber preform G1 and the center of the opening 72 match based on the captured images acquired from the first camera 41 and the second camera 42. According to this configuration, core alignment of the optical fiber preform G1 can be performed accurately and easily.

In the above-described embodiment, the colors of light rays from the LEDs used as the illumination devices are red and blue, but the colors are not limited to these. Other colors may be used as long as the LEDs have different colors (wavelengths). However, when the two wavelengths are separated, it is easier to remove the light rays of the other wavelength with a filter, and it is less likely to be affected by the other light rays. In this respect, it is preferable to use red and blue colors.

### Modification Example

In the above-described embodiment, an example of using the illumination devices (red LED 45 and blue LED 46) with different colors (wavelengths) is described, but the present invention is not limited to this. For example, LEDs of the same color (wavelength) may be used as the illumination devices. When LEDs (illumination devices) of the same color are used, the “imaging acquisition process” in the optical fiber manufacturing method is as follows.

(Imaging Acquisition Process)

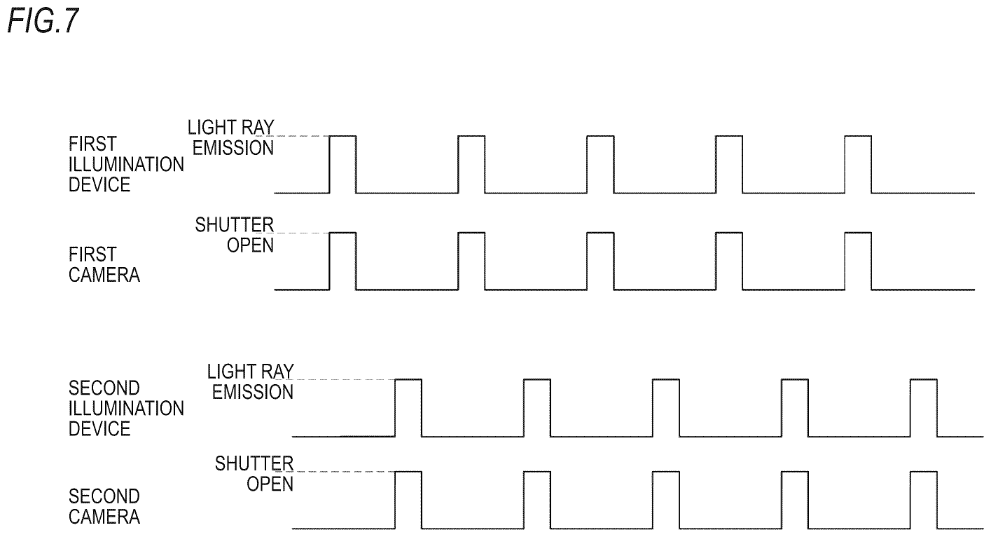

FIG. 7 is a timing chart illustrating timings of light rays emitted from a first illumination device and a second illumination device and opening and closing of shutters of a first camera and a second camera when using the same color LEDs for the first illumination device and the second illumination device,

As illustrated in FIG. 7, the control unit 5 emits first light rays from the first illumination device at a first timing to irradiate the optical fiber preform G1. Further, the control unit 5 opens the shutter of the first camera 41 at the first timing when the first light rays are emitted from the first illumination device, and photographs the optical fiber preform G1 and the opening 72 of the drawing furnace 7 to acquire a first captured image.

Subsequently, the control unit 5 emits second light rays from the second illumination device at a second timing different from the first timing to illuminate the optical fiber preform G1. In addition, the control unit 5 opens the shutter of the second camera 42 installed at a position different from that of the first camera 41 in accordance with the second timing when the second light rays are emitted from the second illumination device, and photographs the optical fiber preform G1 and the opening 72 of the drawing furnace 7 to acquire a second captured image. The first light rays are not emitted from the first illumination device during a period when the shutter of the second camera 42 is opened, and the second light rays are not emitted from the second illumination device during a period when the shutter of the first camera 41 is opened.

The position adjustment process in this modification example is the same as the position adjustment process in the above-described embodiment. The first captured image captured by the first camera 41 and the second captured image captured by the second camera 42 are subject to image processing and the position of the optical fiber preform G1 is adjusted (centered) so that the center of the optical fiber preform G1 and the center of the opening 72 match.

In the manufacturing method of this modification example, the process of acquiring the captured image includes irradiating the optical fiber preform G1 with the first light ray emitted from the first illumination device at the first timing, opening the shutter of the first camera 41 according to the first timing to acquire the first captured image, irradiating the optical fiber preform G1 with the second light ray emitted from the second illumination device at the second timing different from the first timing, and opening the shutter of the second camera 42 according to the second timing to acquire the second captured image. According to the method according to this modification example, the first camera 41 can photograph the optical fiber preform G1 at the first timing only by the first light ray of the first illumination device that is irradiated from an opposite direction across the optical fiber preform G1 without using a filter. Also, the second camera 42 can photograph the optical fiber preform G1 at the second timing only by the second light ray of the second illumination device that is irradiated from an opposite direction across the optical fiber preform G1 without using a filter. Therefore, the first camera 41 and the second camera 42 acquire images illuminated only by the light rays of the illumination device suitable for acquisition of each captured image, and by reducing an influence of light rays from other illumination, it is possible to acquire the first captured image and the second captured image in which the outline edges of the optical fiber preform G1 are easily recognized. Therefore, center alignment of the optical fiber preform G1 and the opening 72 of the drawing furnace 7 can be performed accurately based on these first and second captured images.

Although the present disclosure IS described in detail and with reference to specific embodiments, it will be apparent to those skilled in the art that various changes and modifications can be made without departing from the spirit and scope of the disclosure. Also, the number, positions, shapes, and the like of the constituent members described above are not limited to those in the above-described embodiment, and can be changed to suitable numbers, positions, shapes, and the like in carrying out the present disclosure.

### REFERENCE SIGNS LIST

1: manufacturing apparatus
2: drawing tower
3: feeder
4: imaging unit
5: control unit
6: support rod
7: drawing furnace
8: forced cooling device
9: coating device
10: capstan device
11: winding device
12: glass outer diameter measuring device
31: chuck
32: chuck support portion
33: vertical moving portion
34: horizontal moving portion
41: first camera
42: second camera
43: red filter
44: blue filter
45: red LED (an example of first illumination device)
46: blue LED (an example of second illumination device)
45A, 46A: frame
47: screen
47a: vertical line
71: heater
72: opening
80: target
81: upper area (of target)
c: center (of target)
e: center position (of optical fiber preform)
G1: optical fiber preform
G2: optical fiber
G3: glass fiber
θ1, θ2: angle

1: An optical fiber manufacturing method where an optical fiber preform is drawn while being heated in a drawing furnace to form an optical fiber, the method comprising:
acquiring a captured image obtained by simultaneously photographing the optical fiber preform and an opening of the drawing furnace before drawing the optical fiber preform; and
adjusting a position of the optical fiber preform so that a center of the optical fiber preform and a center of the opening match based on the captured image.

2: The optical fiber manufacturing method according to claim 1, wherein
the captured image includes a first captured image and a second captured image, and
in acquiring the captured image,
the first captured image is acquired by photographing the optical fiber preform and the opening with a first camera, and the second captured image is acquired by photographing the optical fiber preform and the opening with a second camera installed at a position different from the first camera.

3: The optical fiber manufacturing method according to claim 1, wherein
in acquiring the captured image,
the optical fiber preform is irradiated with a first light ray emitted from a first illumination device,
the optical fiber preform is irradiated with a second light ray emitted from a second illumination device and having a wavelength different from that of the first light ray,
a first captured image is acquired by photographing the optical fiber preform and the opening with a first camera having a first filter capable of transmitting only the first light ray, and
a second captured image is acquired by photographing the optical fiber preform and the opening with a second camera having a second filter capable of transmitting only the second light ray.

4: The optical fiber manufacturing method according to claim 3, wherein
a wavelength of the first light ray is red and a wavelength of the second light ray is blue.

5: The optical fiber manufacturing method according to claim 1, wherein
acquiring the captured image includes,
irradiating the optical fiber preform with a first light ray emitted from a first illumination device at a first timing,
opening a shutter of a first camera in accordance with the first timing to acquire the captured image illuminated only by the first light ray,
irradiating the optical fiber preform with a second light ray emitted from a second illumination device at a second timing different from the first timing, and
opening a shutter of a second camera in accordance with the second timing to acquire the captured image illuminated only by the second light ray.

6: The optical fiber manufacturing method according to claim 1, wherein
in acquiring the captured image, the optical fiber preform is irradiated with a reflected light ray reflected by a screen located on a back surface of the optical fiber preform.

7: An optical fiber manufacturing apparatus, comprising:
a drawing furnace that heats and draws an optical fiber preform to form an optical fiber;
a feeder that can grip an upper end of the optical fiber preform and move a position of the optical fiber preform;
at least one camera for simultaneously photographing the optical fiber preform and the opening of the drawing furnace before drawing the optical fiber preform; and
a control unit for controlling the feeder so that a center of the optical fiber preform and a center of the opening match based on the captured image acquired by the at least one camera.
